(19) United States
(12) Patent Application Publication
(10) Pub. No.: US 2012/0037450 A1
(43) Pub. Date: Feb. 16, 2012

(54) HARNESS FOR LINESMEN

(76) Inventors: Simon M. Rowland, Cheshire (GB); Yasir Ahmed, Solihull (GB)

(21) Appl. No.: 13/130,103

(22) PCT Filed: Nov. 20, 2009
(86) PCT No.: PCT/GB2009/002714

§ 371 Date: Sep. 8, 2011

(30) Foreign Application Priority Data
Nov. 20, 2008 (GB) 0821267.2

(51) Int. Cl. A62B 35/00

(52) U.S. Cl. 182/3

(57) ABSTRACT

A safety harness for use on power transmission pylons has a main section with at least a portion thereof being electrically conductive, and a coupling for connecting that portion to earth. The harness may include a lower support section, with the main section having shoulder straps and an upper back portion. The electrically conductive portion is normally located in at least one of shoulder and waist areas of the main section. The earth connection can be made through a lanyard extending from the harness to the respective pylon.

This invention relates to harnesses, and particularly to such harnesses for individuals working on towers. Safety harnesses used in such environments are available from Pammenter & Petrie Ltd of Birmingham BI9 3XJ, United Kingdom. It is concerned particularly with environments in which individuals are exposed to high electric and magnetic fields.

Individuals working in the vicinity of high voltage transmission lines are regularly exposed to high electric and magnetic fields. These fields can induce currents and voltages. The electric fields may induce voltages on the body surface, while the magnetic fields induce internal body currents. The capacitance coupling the body to the transmission lines combined with its capacitance to earth, dictates the induced voltage levels.

Routine checks and inspections of overhead power lines are carried out by linesmen. A typical task would involve climbing to the top of a 400 kV pylon, while maintaining an appropriately safe distance from the live conductors. However, in these conditions linesmen can experience unpleasant electrical discharges that can exceed tolerable levels.

When working on a transmission pylon in the vicinity of one or more high voltage transmission lines, a linesman will become capacitively coupled to the energised conductors supported by the pylon, and his body voltage will rise according to its distance from the transmission lines and the tower structure. If an AC charge is built up on the body due to this coupling, and a small air gap is established between say, a fingertip and a grounded metallic object, there will be an electrical discharge if the induced voltage across the gap exceeds its breakdown voltage. These discharges have various names, one of which is “microshocks”.

For microshocks to occur, the body must reach a substantial voltage and the earthing gap which must be broken down to cause the microshock, must be small. Of course, individual factors will influence the criteria that must be satisfied for microshocks to occur, but an induced voltage as low as 500 volts can be sufficient. Discharge will become noticeable to an individual at voltages above around 800V.

The present invention seeks to remove or at least substantially reduce the sensation of microshocks occurring. It takes advantage of the use by the linesmen of harnesses for safety reasons, and uses it to provide a means by which the total capacitance of the human body can be effectively increased, thus reducing induced voltages well below the “microshock” range. This can be accomplished by making the harness conductive, and connecting it to earth, typically by means of an electrically conductive lanyard which extends from the tower or pylon to the harness, or by a separate connection to the tower which accommodates the movement that the wearer must make. Lanyards are available from Total Access (UK) Ltd of Eccleshall, Staffordshire ST21 6JL, United Kingdom. The harness will of course be isolated from the wearer's body by his or her clothing, creating extra capacitance in parallel to ground.

It is known to provide safety harnesses with electrical connections to earth, to discharge static electricity. Examples are described in Japanese published Patent Specification Nos: 2004-097 562 and 2002-360 719. However, these do not contemplate the provision of a conductive portion in the main section of the harness to effectively increase the capacitance of the wearer's body.

A harness according to the invention has a main section with at least a portion thereof being electrically conductive, and a coupling for making an electrical connection between the conductive portion and the tower. The main section will normally have shoulder straps and an upper back portion, with the harness including a lower section in which the wearer can be supported. The electrical connection to earth is typically provided along a lanyard extending to the tower, although an alternative connection can be made. For example, the coupling may be a lead having a proximal end connected to the conductive portion of the harness main section, and a distal end for attachment to the tower. The distal end of the lead can have a slide for movement relative to the tower, thereby providing a mobile attachment that can move or be moved as the harness wearer moves on the tower. It is preferred that at least two connection mechanisms are provided, for example by lanyards or alternative couplings so that while moving around on a tower a connection is always maintained.

The lanyard normally extending from the harness to the respective tower has a degree of elasticity, and if the electrical coupling is along the lanyard, then conductive elements in the lanyard must of course accommodate any extension. This can be accomplished by using in the lanyard flexible conductive yarns which are re-oriented to accommodate extension, and fabrics formed with knitted such yarns can effectively achieve this. Suitable conductive yarns are available from Shieldex trading US of Palmyraa N.Y. 14522, United States of America, as Silver Plated Nylon 66 yarn 235/34.

While the entirety of the harness may be made conductive to achieve the object of the invention, it is sufficient if only a main section or even a portion of such a main section is conductive. Conveniently, the internal surface of the main section is made electrically conductive, and in preferred embodiments the main section of the harness will have an outer layer and an inner conductive layer. The inner conductive layer can be a fabric woven, stitch-bonded or knitted with conductive yams of the kind referred to above. A variety of conductive materials are known which are suitable to form such an inner layer. This dual layer structure also facilitates the inclusion of an intermediate lining between the outer and inner layers.

The conductive section or layer in a harness of the invention will normally include at least one of the yoke or shoulder and waist or back areas. If both are used, but they are not continuous then they should be electrically connected to each other as well as to earth. However, we have found that microshocks can be substantially eradicated if a conductive section in either of the shoulder or waist area of the harness is connected to earth.

The invention will now be described by way of example and with reference to the accompanying schematic drawings wherein:

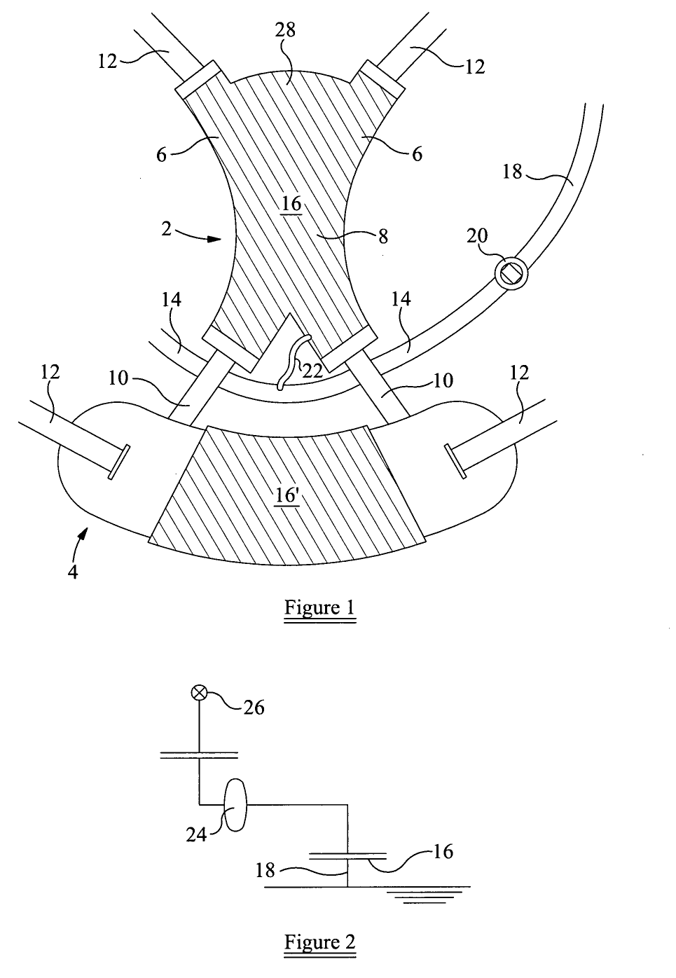

FIG. 1 is an outline view of a harness embodying the invention; and

FIG. 2 illustrates the electro-magnetic circuitry created by the invention.

The harness shown in FIG. 1 has a main section 2 and a lower section 4. The main section includes shoulder extensions 6 and a back section 8. The main and lower sections are directly connected by straps 10. The lower section and the shoulder extensions are connected by straps 12. When worn, the straps 12 extend at the front of the wearer's body, and are held in place by a waistband 14.

The basic construction of the harness shown in FIG. 1 is well known. The main and lower sections will be formed in suitable flexible and normally non-extensible fabric, and held firmly in place by the non-extensible straps 10 and 12, and waistband 14. The harness of the invention differs from the known construction by the inclusion of electrically conductive layers 16 and 16′ (shaded) on the harness internal surface. The layer may be part of the basic harness construction, or a separate layer attached thereto. If the latter, it facilitates the inclusion of an intermediate lining between the basic construction and the conductive layer.

The conductive layer 16 is shown over substantially the entire area of the main section 2 of the harness and part 16′ of the lower section 4, but this is not essential. It can of course cover the entire area of both sections, particularly if it is incorporated in the structure of the respective section. If it is to be installed over only a portion of the harness main section, then it is preferably located in one or both of the back or waist portion 8 and the shoulder portion 28.

The inner conductive layer may be made from a wide variety of materials, but will normally be a woven, knitted or stitch bonded fabric comprising conductive yarns. What is important of course, is that the layer is flexible and readily conformable to the user's body. A suitable material is a fabric woven or knitted with non-conductive, preferably synthetic yarns. Polyester or elastomeric yarns can be used. Particular materials that can be used are metallized fabrics having one or multiple metal compounds. An example of such a fabric is a Nickel-Copper-Silver Conductive Shieldex fabric available from Shieldex Trading US under the trade name Nora Dell. Another is a silver plated fabric, also available from Shieldex Trading US under the trade name MEDTEX E 130 DS.

The conductive layer 16 in the harness of the invention is connected to earth along a lanyard 18 attached to a buckle 20 on the waistband 14. The lanyard, the buckle and the waistband 14 are themselves electrically conductive, and the waistband 14 is connected to the conductive layer 16 by a separate connection shown at 22, although this will normally be incorporated in one or both of the straps 10. The waistband 14 and lanyard 18 are made with conductive fibres to establish conductivity and at least the lanyard will normally be made extendible. This can be accomplished by using suitable weaving, knitting or stitch bonding techniques, and conductive yarns.

All or part of the basic harness construction; the main and lower sections and the straps 10 and 12, can be made conductive in order to complete the conductive pathway to the lanyard. This can be achieved by coating the material of the basic construction with a conductive compound, or by including conductive yarns in the construction, or both in combination. Known harness constructions use polyester based webbing which can be adapted in this manner. If a lanyard is to provide the electrical connection to earth, then a known lanyard may be adapted in this way by adding a conductive component or coating, such as PERRUSTOL AST, a cationic quaternary ammonium compound available from Rudolf GmbH & Co. KG of 82538 Geretsried, Germany. However, metallic ropes can be used, such as those with a stainless steel core.

The lanyard will normally be attached at its distal end to a tower upon which the wearer of the harness is working. As essentially the only difference between a standard harness and a harness of the invention is the inclusion of the conductive layer 16 and the provision of its earthing connection, in practice the harness of the invention will appear substantially identical to such a standard harness. However, in situations where a lanyard is for one reason or another not to be used, then the conductive layer can be earthed via a lead, also extending from the buckle 20, but for attachment to the tower at a more proximate location. If the distal end of the lead can be slidably mounted on an element of the tower, then the harness wearer can move about the tower without having to periodically re-attach the lead.

FIG. 2 provides a simple illustration of how and where voltages are generated by high voltage transmission lines in relation to an individual working indicated at 24, on such a line 26. The transmission of alternating current along the line 26 generates an electromagnetic field coupled to the body of the worker on a tower (not shown) supporting a line 26. If the worker's body is well earthed, this does not lead to a substantial rise in its potential as any induced voltage is easily dissipated. However, commonly a worker on a tower is isolated from an earth connection with the result that his or her body potential can rise significantly. In the event of an individual worker then presenting a finger or other body part in close proximity to the tower or an earthed metallic object, a microshock will occur if the induced voltage across the gap exceeds its breakdown voltage. This is discussed in a paper presented by Yasir Ahmed and Simon M Rowland to the 8th International Power Engineering Conference—IPEC2007, in Singapore on 3^{rd} to 6^{th} December 2007, and to which reference is directed.

Microshocks of the kind described above can be largely eliminated by the present invention. The conductive layer 16 creates added capacitance to earth. The result is an increase in the total capacitance of the wearer's body to the tower, and a reduction in the induced voltage to a level well below that at which a microshock would be generated.

What is claimed is:

1. A harness for use by a linesman working on a tower and proximate high voltage transmission lines, which harness has a main section with at least a portion thereof being electrically conductive, and a coupling for making an electrical connection between the conductive portion and earth.

2. A harness according to claim 1 wherein the main section has shoulder straps and an upper back portion, and the harness includes a lower support section.

3. A harness according to claim 1 wherein a said electrically conductive portion is in at least one of shoulder and waist areas.

4. A harness according to claim 3 wherein a said conductive portion is in both of the shoulder and waist areas, which portions are electrically connected.

5. A harness according to claim 3 wherein a said electrically conductive portion covers both the shoulder and waist areas.

6. A harness according to claim 1 including a lanyard for extending from the harness to said tower.

7. A harness according to claim 6 wherein the coupling is within the lanyard.

8. A harness according to claim 6 wherein the lanyard is extendible.

9. A harness according to claim 7 wherein the lanyard comprises a fabric formed with flexible conductive yarns.

10. A harness according to claim 9 wherein the fabric is knitted.

11. A harness according to claim 1 wherein the coupling is a lead having a proximal end connected to the conductive portion of the harness main section and a distal end for attachment to a said tower.

12. A harness according to claim 11 wherein the distal end of the lead has a slide for movement relative to said tower.

13. A harness according to claim 12 wherein the slide is adapted for sliding on a conductive rail on a said tower.

14. A harness according to claim 1 wherein said electrically conductive portion is on the internal surface of the main section of the harness.

15. A harness according to claim 1 wherein the main section has an outer layer, and an inner conductive layer.

16. A harness according to claim 15 wherein the main section has an intermediate lining between the outer and inner layers.

17. A harness according to claim 15 wherein the inner conducive layer is a metallized fabric.

18. A harness according to claim 17 wherein the metallized fabric has a plurality of metal components.
